(19) United States
(12) Patent Application Publication
(10) Pub. No.: US 2018/0152711 A1
(43) Pub. Date: May 31, 2018

(54) METHOD AND APPARATUS FOR DETERMINING CODING UNIT DEPTH BASED ON HISTORY

(71) Applicant: AJOU UNIVERSITY INDUSTRY-ACADEMIC COOPERATION FOUNDATION, Suwon-si (KR)

(72) Inventors: Myung Hoon SUNWOO, Seoul (KR); Jong Hyun BAE, Suwon-si (KR)

(73) Assignee: AJOU UNIVERSITY INDUSTRY-ACADEMIC COOPERATION FOUNDATION, Suwon-si (KR)

(21) Appl. No.: 15/819,027

(22) Filed: Nov. 21, 2017

(30) Foreign Application Priority Data
Nov. 29, 2016 (KR) 10-2016-0160678

(51) Int. Cl. H04N 19/147; H04N 19/172; H04N 19/119

(52) U.S. Cl. CPC H04N 19/147; H04N 19/119; H04N 19/172

(57) ABSTRACT

Provided is a history based CU depth determining method. A history based CU depth determining method according to an exemplary embodiment of the present disclosure is a method for determining depths of a plurality of coding units (CU) included in each of a plurality of coding tree units (CTU) which configures a frame of a video, including: dividing a plurality of previous CTUs of a plurality of previous frames which are the same position as a current CTU of a current frame into a plurality of areas to generate depth history information including information of a CU depth for each of the plurality of areas; determining a plurality of depth candidates for a CU depth for each of the plurality of areas of the current CTU, based on the depth history information; and selecting an optimal CU depth among the plurality of depth candidates for each of the plurality of areas of the current CTU, through a rate-distortion cost (RD-cost) calculation.

### CROSS-REFERENCE TO RELATED APPLICATIONS

This application claims the priority of Korean Patent Application No. 10-2016-0160678 filed on Nov. 29, 2016, in the Korean Intellectual Property Office, the disclosure of which is incorporated herein by reference.

### BACKGROUND

### Field

The present disclosure relates to a method and an apparatus for determining a coding unit (CU) depth for a CTU of a current frame based on a history in a high efficiency video coding HEVC, and more particularly, to a method and an apparatus for determining a coding unit (CU) depth for a CTU of a current frame to be coded using information of a CU depth for a CTU of a plurality of previous frames.

### Description of the Related Art

Recently, as access to multimedia contents has become easier by development of a DTV, mobile devices, and various online video streaming services, a demand for a high resolution and high quality video is increasing. Therefore, in order to transmit a high quality video, a high performance video compression technology is required.

High efficiency video coding (HEVC) has a compression performance which is approximately two times better than H.264/MPEG-4 AVC which is an existing video compression standard while maintaining the same image quality as H.264/MPEG-4 AVC. Although HEVC achieves excellent compression performance as described above, HEVC has a fatal drawback in that a computational complexity of an encoder is very high. In order to improve the above-mentioned drawback, studies for a method of reducing the computational complexity of the encoder while minimizing deterioration of an image quality of the video are necessary.

An HEVC standard of the related art performs coding by dividing a video frame in the unit of a coding tree unit (CTU). Generally, a size of one CTU is 64×64 and a coding unit (CU), a prediction unit (PU), and a transform unit (TU) having various sizes are divided to have an optimal rate-distortion cost (RD-cost) therein. As illustrated in FIG. 6, the CTU starts from a CU depth of zero having a size of 64×64 and reaches a depth 3 having a size of 8×8 and has a structure in which a quad-tree division method by which one CU is divided into four sub CU blocks having the same size is recursively repeated. Further, as illustrated in FIG. 5, for each CU depth, a rate-distortion cost for a total of eight PU modes and TU division is calculated. As described above, since the rate-distortion cost calculation is performed for combinations of the CU, PU, and TU available for all depths, a computational amount of an encoder is drastically increased.

Therefore, there is a necessity for a CU depth determining method and apparatus which may reduce a computational amount at the time of HEVC coding by improving an HEVC coding method of a related art to limit a range of a CU depth in advance based on a history.

Related art is disclosed in Korean Registered Patent Publication No. 10-1621358 (entitled an HEVC coding apparatus and an intra prediction mode determining method, published on May 10, 2016).

### SUMMARY

The present disclosure provides a CU depth determining method and apparatus which may reduce a computational amount at the time of HEVC coding by limiting a range of a CU depth for a CTU of a current frame to be coded in advance using CU depth information for a CTU of a plurality of previous frames.

Technical problems of the present disclosure are not limited to the above-mentioned technical problems, and other technical problems, which are not mentioned above, can be clearly understood by those skilled in the art from the following descriptions.

According to an aspect of the present disclosure, there is provided a history based CU depth determining method which determines depths of a plurality of coding units (CU) included in each of a plurality of coding tree units (CTU) which configures a frame of a video, including dividing a plurality of previous CTUs of a plurality of previous frames which are the same position as a current CTU of a current frame into a plurality of areas to generate depth history information including information of a CU depth for each of the plurality of areas, determining a plurality of depth candidates for a CU depth for each of the plurality of areas of the current CTU, based on the depth history information; and selecting an optimal CU depth among the plurality of depth candidates for each of the plurality of areas of the current CTU, through a rate-distortion cost (RD-cost) calculation.

In the determining of a plurality of depth candidates, with respect to each of the plurality of areas of the current CTU, when the CU depth information among the same areas of the plurality of previous CTU matches, the plurality of depth candidates may be determined with a first CU depth which is the matching CU depth and at least one second CU depth which is different from the first CU depth within a predetermined first range and when the CU depth information does not match, a weighted average CU depth obtained by calculating a weighted average of CU depth information among the same areas of the plurality of previous CTU may be calculated to determine the plurality of depth candidates with a plurality of third CU depths which is within a predetermined second range from the weighted average CU depth.

In the selecting of an optimal CU depth, the rate-distortion cost calculation may be performed only on a part of the entire prediction unit (PU) for the at least one second CU depth included in the plurality of depth candidates.

The determining of a plurality of depth candidates may include, with respect to each of the plurality of areas of the current CTU, calculating a weighted average CU depth obtained by weighting an average of the CU depth information among the same areas of the plurality of previous CTUs; and determining the plurality of depth candidates with a plurality of third CU depths which is within a predetermined second range from the weighted average CU depth.

The weighted average CU depth may be calculated by assigning a differential weight to CU depth information among the same areas of the plurality of previous CTUs in accordance with an order of time.

The predetermined second range may be based on a standard deviation for CU depth information among the same areas of the plurality of previous CTUs.

The plurality of areas may be obtained by dividing the CTU by four.

The plurality of previous frames may be a predetermined number of previous frames which are connected in order with the current frame.

The depth history information may include a maximum value of a depth of at least one CU corresponding to each of the plurality of areas.

According to another aspect of the present disclosure, there is provided a history based CU depth determining apparatus which determines a depth of a plurality of CUs included in each of a plurality of CTUs which configures a frame of a video, including: a generating unit which divides a plurality of previous CTUs of a plurality of previous frames which are the same position as a current CTU of a current frame into a plurality of areas to generate depth history information including information of a CU depth for each of the plurality of areas; a candidate determining unit which determines a plurality of depth candidates for a CU depth for each of the plurality of areas of the current CTU, based on the depth history information; and a selecting unit which selects an optimal CU depth among the plurality of depth candidates through a rate-distortion cost operation on each of the plurality of areas of the current CTU.

With respect to each of the plurality of areas of the current CTU, when the CU depth information among the same areas of the plurality of previous CTU matches, the candidate determining unit may determine the plurality of depth candidates with a first CU depth which is the matching CU depth and at least one second CU depth which is different from the first CU depth within a first predetermined range, and when the CU depth information does not match, the candidate determining unit may calculate a weighted average CU depth obtained by weighting an average of CU depth information among the same areas of the plurality of previous CTU to determine the plurality of depth candidates with a plurality of third CU depths which is within a second predetermined range from the weighted average CU depth.

The selecting unit may perform the rate-distortion cost operation only on a part of the entire prediction unit (PU) for the at least one second CU depth included in the plurality of depth candidates.

The candidate determining unit, with respect to each of the plurality of areas of the current CTU, may calculate a weighted average CU depth obtained by weighting an average of the CU depth information among the same area of the plurality of previous CTUs; and determine the plurality of depth candidates with a plurality of third CU depths which is within a predetermined second range from the weighted average CU depth.

The weighted average CU depth may be calculated by assigning a differential weight to CU depth information among the same areas of the plurality of previous CTUs in accordance with an order of time.

The predetermined second range may be based on a standard deviation for CU depth information among the same areas of the plurality of previous CTUs.

The plurality of areas may be obtained by dividing the CTU by four.

The plurality of previous frames may be a predetermined number of previous frames which are connected in order with the current frame.

The depth history information may include a maximum value of a depth of at least one CU corresponding to each of the plurality of areas.

According to an exemplary embodiment of the present disclosure, a CU depth determining method and apparatus which limit a range of a CU depth for a CTU of a current frame to be coded in advance using CU depth information for a CTU of a plurality of previous frames are used at the time of HEVC coding, thereby reducing a computational amount required for HEVC coding.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a flowchart illustrating for explaining a history based CU depth determining method according to an exemplary embodiment of the present disclosure;

FIG. 2 is a flowchart illustrating for explaining a method for determining a plurality of depth candidates according to an exemplary embodiment of the present disclosure;

FIG. 3 is a flowchart illustrating for explaining a method for determining a plurality of depth candidates according to another exemplary embodiment of the present disclosure;

FIG. 4 is a view illustrating for explaining a history based CU depth determining apparatus according to an exemplary embodiment of the present disclosure;

FIG. 5 is a view illustrating for explaining a relationship of a CTU and a CU, a PU, and TU in HEVC coding according to an exemplary embodiment of the present disclosure;

FIG. 6 is a view illustrating for explaining a depth of a CU in the HEVC decoding according to an exemplary embodiment of the present disclosure;

FIG. 7 is a view illustrating for explaining that a plurality of previous frames and a current frame according to an exemplary embodiment of the present disclosure have a CTU in the same position;

FIG. 8 is a view illustrating for explaining a depth candidate determining result according to an exemplary embodiment of the present disclosure when CU depth information of the plurality of previous CTUs among the same areas matches;

FIG. 9 is a view illustrating for explaining a process of calculating a CU depth for every area of a CTU of a current frame from a CU depth history for every area of the CTU of a plurality of previous frames according to an exemplary embodiment of the present disclosure; and

FIG. 10 is a view illustrating for explaining a result obtained by comparing a performance of an HEVC coding algorithm to which the history based CU depth determining method according to an exemplary embodiment of the present disclosure is applied with another algorithm.

### DETAILED DESCRIPTION OF THE EMBODIMENT

Those skilled in the art may make various modifications to the present disclosure and the present disclosure may have various embodiments thereof, and thus specific embodiments will be illustrated in the drawings and described in detail in the detailed description. However, this does not limit the present disclosure within specific exemplary embodiments, and it should be understood that the present disclosure covers all the modifications, equivalents and replacements within the spirit and technical scope of the present disclosure. In the description of respective drawings, similar reference numerals designate similar elements.

Terminologies such as first, second, A, and B may be used to describe various components but the components are not limited by the above terminologies. The above terminologies are used only to discriminate one component from the other component. For example, without departing from the scope of the present disclosure, a first component may be referred to as a second component, and similarly, a second component may be referred to as a first component. A term of and/or includes combination of a plurality of related elements or any one of the plurality of related elements.

It should be understood that, when it is described that an element is “coupled” or “connected” to another element, the element may be directly coupled or directly connected to the other element or coupled or connected to the other element through a third element. On the contrary, it should be understood that when an element is referred to as being “directly connected to” or “directly coupled to” another element, another element does not intervene therebetween.

Terminologies used in the present application are used only to describe specific exemplary embodiments, and are not intended to limit the present disclosure. A singular form may include a plural form if there is no clearly opposite meaning in the context. In the present disclosure, it should be understood that term “include” or “have” indicates that a feature, a number, a step, an operation, a component, a part or the combination thereof described in the specification is present, but do not exclude a possibility of presence or addition of one or more other features, numbers, steps, operations, components, parts or combinations, in advance.

If it is not contrarily defined, all terms used herein including technological or scientific terms have the same meaning as those generally understood by a person with ordinary skill in the art. Terms defined in generally used dictionary shall be construed that they have meanings matching those in the context of a related art, and shall not be construed in ideal or excessively formal meanings unless they are clearly defined in the present application.

Hereinafter, exemplary embodiments according to the present disclosure will be described in detail with reference to accompanying drawings.

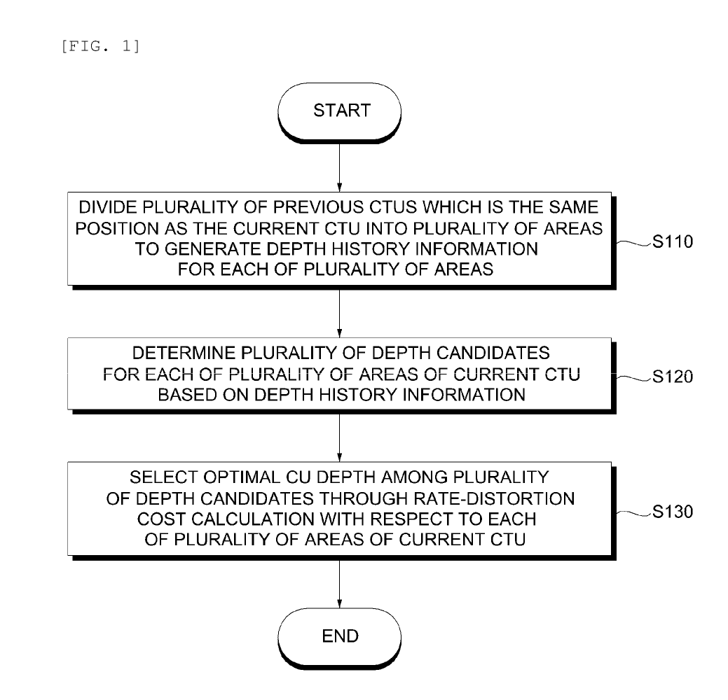

FIG. 1 is a flowchart illustrating for explaining a history based CU depth determining method according to an exemplary embodiment of the present disclosure.

In step S110, a CU depth determining apparatus divides a plurality of previous CTUs of a plurality of previous frames which is the same position as a current CTU of a current frame into a plurality of areas to generate depth history information including information of a CU depth for each of the plurality of areas.

Here, high efficiency video coding (HEVC) is a next generation video coding technology of H.264/MPEG-4 AVC which is an existing video compression standard and is also called H.265. In the meantime, in HEVC, the coding is performed with a plurality of CTUs (maximum 64×64) which configures each frame as a unit and the compression performance is up to two times better than the existing H.264.

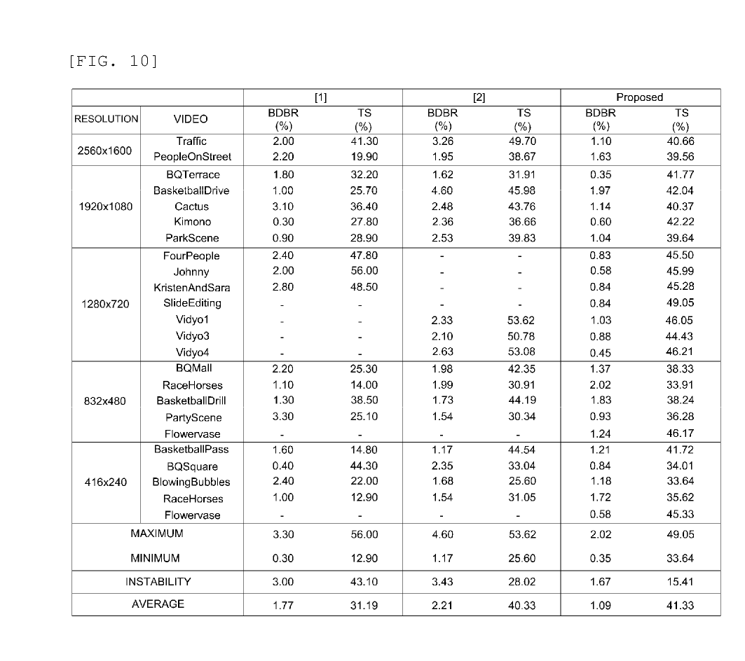

In the meantime, referring to FIG. 9, a current CTU 910 which is the same position as the previous CTU is divided into a plurality of areas 912, 914, 916, and 918 and the CU depth determining apparatus collects information of the CU depth for the plurality of same areas 912, 914, 916, and 918 from the previous CTU which is the same position as the current CTU 910 to generate depth history information. In this case, the plurality of areas 912, 914, 916, and 918 are virtual areas but it does not mean that the CTU is divided into smaller CTUs.

For example, a depth history of the corresponding CUs of five previous CTUs of the upper left area 912 is {2, 3, 1, 1, 2}, a depth history of the corresponding CUs of five previous CTUs of the upper right area 914 is {2, 2, 2, 2, 2}, a depth history of the corresponding CUs of five previous CTUs of the lower left area 916 is {1, 1, 2, 1, 2}, and a depth history of the corresponding CUs of five previous CTUs of the lower right area 918 is {3, 1, 2, 3, 1}. In this case, the depth history information may include all information {2, 3, 1, 1, 2}, {2, 2, 2, 2, 2}, {1, 1, 2, 1, 2}, and {3, 1, 2, 3, 1} for each of four areas 912, 914, 916, and 918 of the current CTU 910.

According to another exemplary embodiment, the plurality of areas may be areas obtained by dividing the CTU by four.

That is, the CU depth determining apparatus divides each of the plurality of CTUs which configures a frame of a video by four to generate depth history information so as to include CU depth information for every area.

However, the CU depth determining apparatus may also divide each of the plurality of CTUs by a number other than four (for example, two, eight, or sixteen) depending on a computational performance or a complexity of a video.

Further, according to another exemplary embodiment, the plurality of previous frames may be a predetermined number of previous frames which are connected in order with the current frame.

For example, referring to FIG. 7, when it is assumed that a unique serial number is assigned to each of the frames which configure the video, a serial number of the current frame may be t. In this case, serial numbers of five previous frames may be t−5, t−4, t−3, t−2, and t−1. The reason that the plurality of previous frames having serial numbers which are continuous with the serial number of the current frame is used to determine the CU depth of the current frame as described above is that it is considered that as the previous frame is closer to the current frame, the previous frame is more likely to have a CU depth similar to that of the current frame.

According to another exemplary embodiment, the depth history information may include a maximum value of a depth of at least one CU corresponding to each of the plurality of areas.

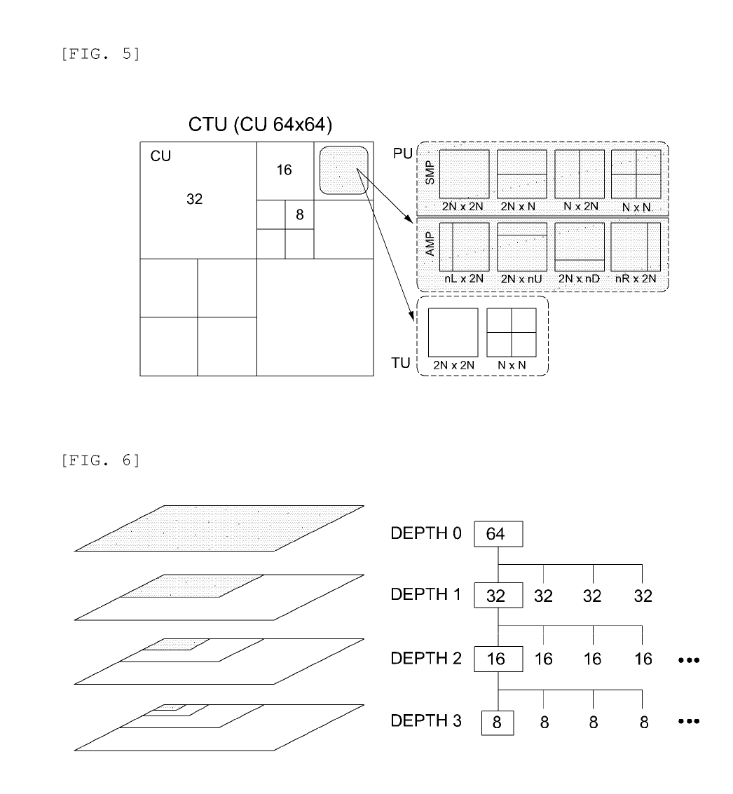

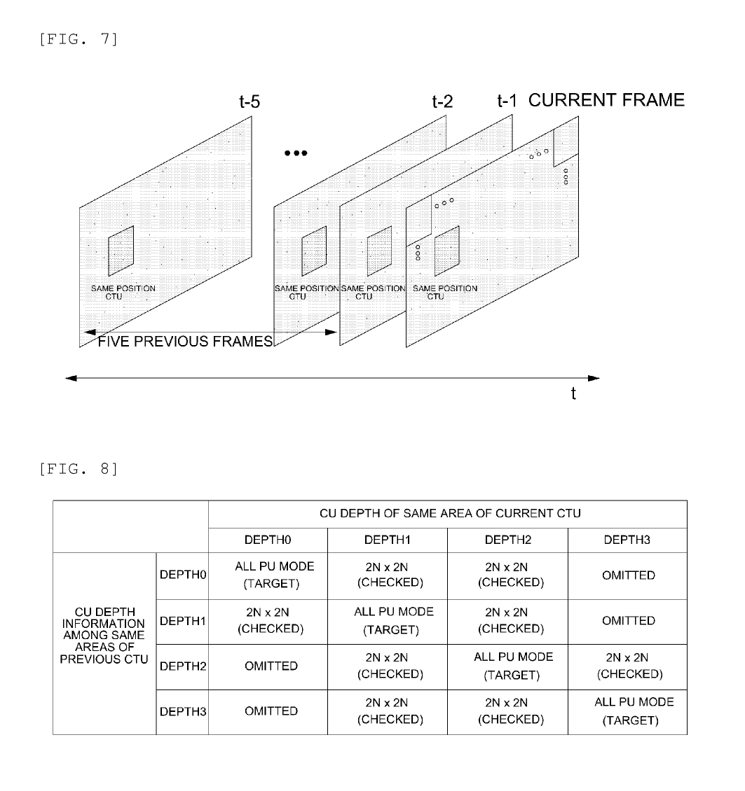

For example, referring to FIG. 5, with respect to four areas (upper left, upper right, lower left, and lower right) of the previous CTU, the depth history information may include a maximum value at least one CU corresponding to each area. That is, since a size of the corresponding CU of the upper left area is 32×32, the maximum value of the CU depth is 1. Since a minimum value of a size of the corresponding CU of the upper right area is 8×8, the maximum value of the CU depth is 3, since a minimum value of a size of the corresponding CU of the lower left area is 16×16, the maximum value of the CU depth is 2, and since a size of the corresponding CU of the lower right area is 32×32, the maximum value of the CU depth is 1.

In step S120, the CU depth determining apparatus determines a plurality of depth candidates for a CU depth for each of the plurality of areas of the current CTU based on the depth history information.

That is, the CU depth determining apparatus determines a plurality of depth candidates using the depth history information and details of a method for determining a plurality of depth candidates will be specifically described in the following exemplary embodiment.

According to another exemplary embodiment, when the CU depth determining apparatus determines a plurality of depth candidates, the CU depth determining apparatus may adaptively determine the plurality of depth candidates depending on whether CU depth information among the same areas of the plurality of previous CTUs matches for each of the plurality of areas of the current CTU.

That is, when all the CU depth information among the same areas of the plurality of previous CTUs matches, the CU depth determining apparatus may determine a plurality of depth candidates with the first CU depth which is the matching CU depth and at least one second CU depth which is different from the first CU depth within a predetermined first range.

Further, when the CU depth information among the same areas of the plurality of previous CTUs does not match, the CU depth determining apparatus calculates a weighted average CU depth obtained by calculating a weighted average of the CU depth information among the same areas of the plurality of previous CTUs to determine the plurality of depth candidates with a plurality of third CU depths which is within a predetermined second range from the weighted average CU depth.

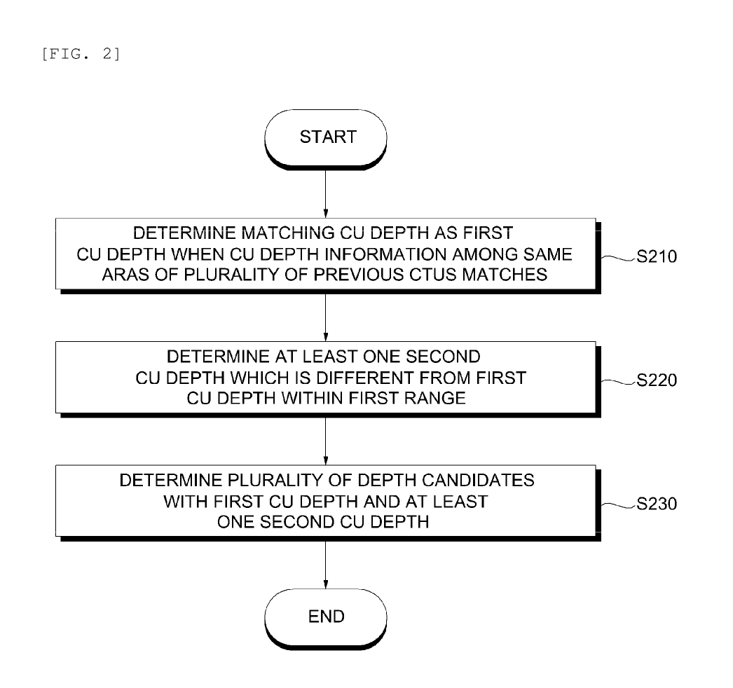

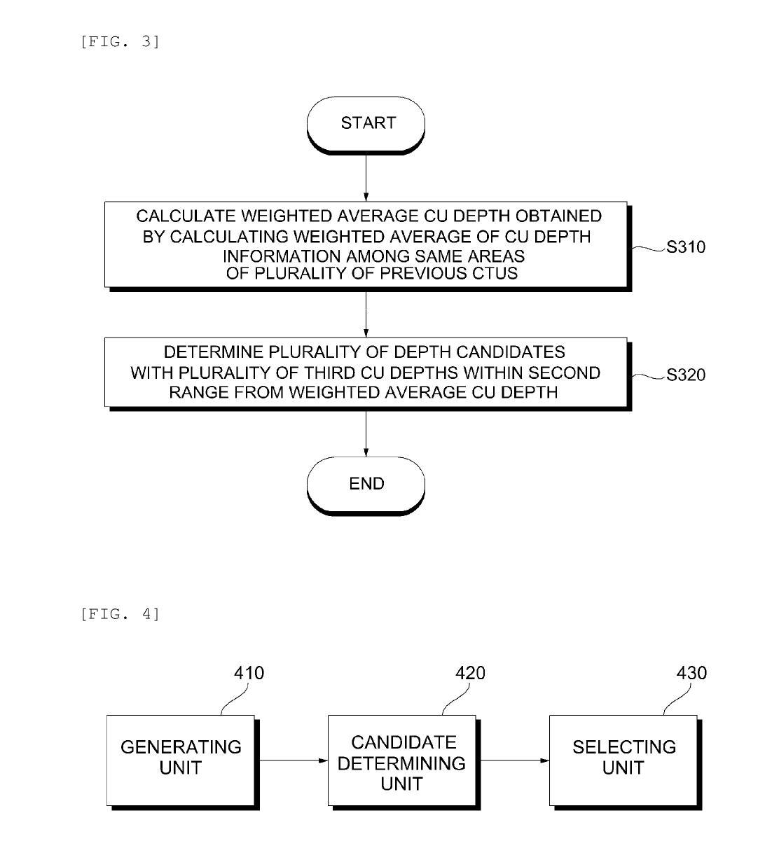

In this case, details that the CU depth determining apparatus determines a plurality of depth candidates with the first CU depth and at least one second CU depth will be specifically described with reference to FIG. 2 and details that the CU depth determining apparatus determines a plurality of depth candidates with a plurality of third CU depths will be specifically described with reference to FIG. 3.

According to another exemplary embodiment, regardless of whether the CU depth information among the same areas of the plurality of previous CTUs matches, the CU depth determining apparatus calculates a weighted average CU depth obtained by calculating a weighted average of the CU depth information among the same areas of the plurality of previous CTU to determine the plurality of depth candidates with a plurality of third CU depths which is within a predetermined second range from the weighted average CU depth.

In the meantime, details of determination of a plurality of depth candidates with a plurality of third CU depths will be specifically described with reference to FIG. 3.

Finally, in step S130, the CU depth determining apparatus selects an optimal CU depth among the plurality of depth candidates through a rate-distortion cost calculation for each of the plurality of areas of the current CTU.

For example, the CU depth determining apparatus may select one of the pluralities of depth candidates having the best result for the RD-cost calculation as an optimal CU depth, for each of the plurality of areas of the current CTU of a current frame to be coded.

In the meantime, the CU depth determining apparatus determines a plurality of depth candidates for every area of each CTU so that an RD-cost calculation of the PU is performed only for a CU depth in a predetermined range without performing the RD-cost calculation of a total of eight PUs on all CU depths from 0 to 3 so that a computational amount at the time of HEVC coding may be reduced.

Further, referring to FIG. 10, a simulation result obtained by performing an algorithm [1] which uses a characteristic of spatial and temporal redundancy of Shen, an algorithm [2] by which a part of the video frame of Xiong in which there is more motion of an object is coded to a CU having a smaller size, and a HEVC coding algorithm (proposed) to which the present disclosure is applied in a Low-delay B (LB-Main) profile environment provided in the HEVC standard is illustrated.

More specifically, at a bjontegaard delta bitrate (BDBR), in the HEVC coding algorithm to which the present disclosure is applied, only a lower bit rate (1.09%) on average than the algorithms [1] and [2] is increased, so that more excellent performance is obtained. Further, in terms of time saving (TS), the HEVC coding algorithm has a higher average (41.33%) than the algorithms [1] and [2], which shows more excellent performance. Further, in terms of instability, the HEVC coding algorithm to which the present disclosure is applied has a lower average (1.67%) than the algorithms [1] and [2], which shows more excellent performance.

As described above, the history based CU depth determining method according to an exemplary embodiment of the present disclosure uses CU depth information for CTUs of a plurality of previous frames to limit a range of the CU depth for a CTU of a current frame to be coded in advance, thereby reducing a computational amount at the time of the HEVC coding.

FIG. 2 is a flowchart illustrating for explaining a method for determining a plurality of depth candidates according to an exemplary embodiment of the present disclosure.

In step S210, when all the CU depth information among the same areas of the plurality of previous CTUs matches, the CU depth determining apparatus determines the matching CU depth as a first CU depth.

For example, referring to FIG. 9, the CU depth determining apparatus determines whether CU depth information of the same area of the five previous CTUs included in five previous frames t−1, t−2, . . . , t−5 matches for four areas 912, 914, 916, and 918 of the current CTU 910. Since all the depth histories {2, 2, 2, 2, 2} of the CU of the same area of the five previous CTUs corresponding to the upper right area 914 match to be 2, 2 which is the matching CU depth may be determined as a first CU depth.

In step S220, the CU depth determining apparatus determines at least one second CU depth which is different from the first CU depth within a first range.

That is, at least one second CU depth may be determined to be different from the first CU depth within the first range. More specifically, when the first range is 2, a difference between at least one second CU depth and the first CU depth may be 1 or 2.

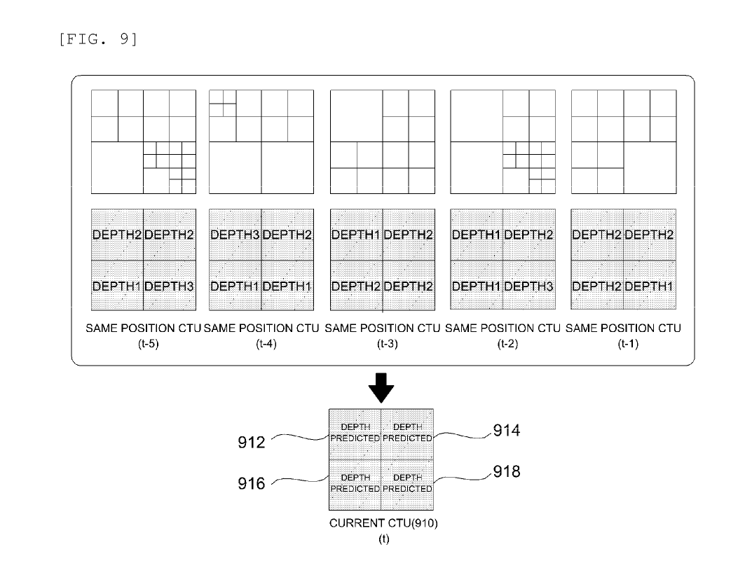

According to another exemplary embodiment, referring to FIG. 8, when the first range is 2, if the first CU depth is 0, the second CU depth may be determined to be 1 or 2. Further, if the first CU depth is 1, the second CU depth may be determined to be 0 or 2. Furthermore, if the first CU depth is 2 the second CU depth may be determined to be 1 or 3. Further, if the first CU depth is 3, the second CU depth may be determined to be 1 or 2.

Therefore, in the upper right area 914 of the current CTU 910 of FIG. 9, the CU depth determining apparatus determines the first CU depth to be 2, so that the second CU depth may be determined to be 1 and 3. In this case, since the CU depth 0 is not determined as the first CU depth and the second CU depth, the RD-cost calculation is omitted.

According to another exemplary embodiment, when the first range is 2, if the first CU depth is 0, the second CU depth may be determined to be 1. Further, if the first CU depth is 1, the second CU depth may be determined to be 0 or 2. Furthermore, if the first CU depth is 2, the second CU depth may be determined to be 1 or 3. Further, if the first CU depth is 3, the second CU depth may be determined to be 2. In this case, when the first CU depth is 1 or 2, two second CU depths are determined. This is because the CU depth determining apparatus does not determine which one of two values is determined as the second CU depth.

In step S230, the CU depth determining apparatus determines a plurality of depth candidates with the first CU depth and at least one second CU depth.

That is, the plurality of depth candidates may be configured by the first CU depth and at least one second CU depth. For example, when the first range is 2, if the first CU depth is 0, the second CU depth is 1 and 2. Therefore, the plurality of depth candidates is a total of three that is, 0, 1, and 2.

According to another exemplary embodiment, when the CU depth determining apparatus selects an optimal CU depth, a rate-distortion cost calculation may be performed only on a part of the entire prediction unit PU for at least one second CU depth included in the plurality of depth candidates.

For example, when the first range in the upper right area 914 of the current CTU 910 of FIG. 9 is 2, if the first CU depth is 2, the second CU depth is 1 and 3. Therefore, the plurality of depth candidates may be a total of three that is, 1, 2, and 3. In this case, it is considered that the CU depth of the current CTU is more likely to be the same as the first CU depth, but is less likely to be the same as the second CU depth. This is because the first CU depth is a CU depth which matches in all the previous CTUs of the plurality of previous frames.

Therefore, the CU depth determining apparatus performs the RD-cost calculation on all eight PUs (2N×2N, 2N×N, N×2N, N×N, nL×2N, 2N×nU, 2N×nD, and nR×2N) for the first CU depth and performs the RD-cost calculation only on one PU (for example, 2N×2N) for the second CU depth, so that a computational amount reducing effect may be maximized.

More specifically, when the upper right area 914 of the current CTU 910 of FIG. 9 is referred, the CU depth determining apparatus performs the RD-cost calculation on all eight PUs for the first CU depth, 2, and performs the RD-cost calculation only on the PU of 2N×2N for two second CU depths, 1 and 3. In contrast, the RD-cost calculation for a PU is omitted on the CU depth, 0, which does not belong to the first CU depth and the second CU depth, so that the computational amount required for the HEVC coding may be reduced.

FIG. 3 is a flowchart illustrating for explaining a method for determining a plurality of depth candidates according to another exemplary embodiment of the present disclosure.

In step S310, the CU depth determining apparatus calculates a weighted average CU depth obtained by calculating a weighted average of the CU depth information among the same areas of the plurality of previous CTUs.

Generally, it is considered that there is a high possibility that the CU depth information between frames which are temporally closer to each other for the same area of the CTU is similar to each other and there is a high possibility that the CU depth information between frames which are temporally distant from each other is not similar to each other.

Therefore, the CU depth determining apparatus calculates a weighted average of the CU depth information for the same area of the plurality of previous CTUs in consideration of the possibility to calculate a weighted average CU depth with a higher reliability.

According to another exemplary embodiment, the weighted average CU depth may be calculated by assigning a differential weight to the CU depth information between the same areas of the plurality of previous CTUs in accordance with an order of time.

Specifically, the CU depth determining apparatus assigns a higher weight to a CU depth information of the same area of the previous CTU which belongs to a previous frame closer to the current frame and assigns a lower weight to a previous frame which is distant from the current frame.

For example, a differential weight in accordance with an order of time may be calculated by the following Equation 1.

y=−0.25x+1.75 [Equation 1]

Here, x refers to a difference of an order from the current frame and y is a calculated weight.

More specifically, when there are five previous frames, the weight may be calculated using Equation 1, such that when the differential weight is 1, that is, x=1, y=1.5, when x=2, y=1.25, when x=3, y=1.0, when x=4, y=0.75, and when x=5, y=0.5. That is, it is confirmed that the larger the difference from the current frame, the smaller the calculated weight.

In this case, the total of the differential weights needs to match the number of previous frames, otherwise, the value of the weighted average CU depth may be distorted. For example, the above-calculated weight is 1.5+1.25+1.0+0.75+0.5 (=5), which matches 5 which is the number of previous frames.

In the meantime, the weighted average CU depth may be calculated using the differential weights by the following Equation 2.

$$E ( {X}^{′} ) = \frac{1}{n} \sum {w}_{i} \times {X}_{i}^{′} \qquad [ Equation 2 ]$$

Here, E(X′) is a weighted average CU depth, n is the number of previous frames, wⱼ is a weight of a CU depth of an i-th previous frame, and Xi′ is a CU depth of an i-th previous frame.

In step S330, the CU depth determining apparatus determines a plurality of depth candidates with a plurality of third CU depths within a predetermined second range from the weighted average CU depth.

For example, when the weighted average CU depth is 1.2 and the second range is 1, the CU depth determining apparatus determines the plurality of depth candidates with a plurality of third CU depths configured by CU depths of 1 and 2 which are between 0.2 and 2.2.

According to another exemplary embodiment, the predetermined second range may be based on a standard deviation for CU depth information among the same areas of the plurality of previous CTUs.

In the meantime, the CU depth determining apparatus calculates a standard deviation of the CU depth information among the same areas of the plurality of previous CTUs and determines a plurality of third CU depths using the calculated standard deviation. In this case, the third CU depth may be represented by the range of the following Equation 3.

E(X′)−σ≤CU≤E(X′)+σ [Equation 3]

Here, E (X′) is a weighted average CU depth, σ is a standard deviation of the CU depth information, and the CU is a third CU depth.

According to still another exemplary embodiment, both values of E(X′)−σ and E(X′)+σ are rounded up, to be integers. Further, when the rounded value is smaller than 0 or exceeds 3, the value may be limited to 0 and 3.

According to still another exemplary embodiment, the CU depth determining apparatus may determine a plurality of depth candidates using the weighted average CU depth as follows.

The CU depth history of the same area of five previous CTUs corresponding to the upper left area 912 of the current CTU 910 of FIG. 9 is (t−5, t−4, t−3, t−2, t−1)={2, 3, 1, 1, 2}. Further, a weight according to a temporal order of each CU depth using Equation 1 is (t−5, t−4, t−3, t−2, t−1)={0.5, 0.75, 1.0, 1.25, 1.5}. Therefore, when a weight is applied to the depth history of the CU, a CU depth history into which (t−5, t−4, t−3, t−2, t−1)={1, 2.25, 1, 1.25, 3} is reflected as a weight is calculated. In this case, when Equation 2 is used, the weighted average CU depth is calculated to be (1+2.25+1+1.25+3)/5=1.7.

In the meantime, when a standard deviation of five CU depth information included in the CU depth history into which the weight is reflected is calculated using the following Equation 4, the standard deviation is calculated as 0.75.

$$σ = \sqrt{\frac{1}{n} \sum {( {X}_{i}^{′} - E ( {X}^{′} ) )}^{2}} \qquad [ Equation 4 ]$$

Here, σ is a standard deviation of the CU depth information, n is a total number of CU depth information of the previous CTU, Xi is CU depth information into which a weight of an i-th previous CTU is reflected, and E(X′) is a weighted average CU depth.

Therefore, when a range of the third CU depth is represented using Equation 3, 1.7−0.75≤CU≤1.7+0.75. As a result, the CU depth determining apparatus may determine 1 and 2 which are the third CU depths as the depth candidates. In this case, the CU depth determining apparatus performs the RD-cost calculation on all eight PUs for 1 and 2 of the third CU depth included in the depth candidates and omits the RD-cost calculation on the PU for 0 and 1 which are the remaining CU depths which are not included in the depth candidates. Therefore, a computational amount required for the HEVC coding may be reduced.

In the meantime, a third CU depth for the lower left area 916 and a lower right area 918 of the current CTU 910 of FIG. 9 may be determined similarly to the upper left area 912.

FIG. 4 is a view illustrating for explaining a history based CU depth determining apparatus according to an exemplary embodiment of the present disclosure.

Referring to FIG. 4, a history based CU depth determining apparatus 400 according to an exemplary embodiment of the present disclosure includes a generating unit 410, a candidate determining unit 420, and a selecting unit 430.

The generating unit 410 divides a plurality of previous CTUs of a plurality of previous frames which is the same position as a current CTU of a current frame into a plurality of areas to generate depth history information including information of a CU depth for each of the plurality of areas.

According to another exemplary embodiment, the plurality of areas may be areas obtained by dividing the CTU by four.

Further, according to another exemplary embodiment, the plurality of previous frames may be a predetermined number of previous frames which are connected in order with the current frame.

According to another exemplary embodiment, the depth history information may include a maximum value of at least one CU depth corresponding to each of the plurality of areas.

The candidate determining unit 420 determines a plurality of depth candidates for CU depths for each of the plurality of areas of the current CTU based on the depth history information.

According to another exemplary embodiment, when the CU depth information of each of the plurality of areas of the current CTU matches among the same areas of the plurality of previous CTUs, the candidate determining unit 420 determines a plurality of depth candidates with a first CU depth which is a matching CU depth and at least one second CU depth which is different from the first CU depth within a predetermined first range. When the CU depth information does not match, the candidate determining unit 420 may calculate a weighted average CU depth obtained by weighting an average of the CU depth information between the same area of the plurality of previous CTUs to determine the plurality of depth candidates with a plurality of third CU depths which is within a predetermined second range from the weighted average CU depth.

According to another exemplary embodiment, the candidate determining unit 420 may calculate a weighted average CU depth obtained by weighting an average of the CU depth information among the same areas of the plurality of previous CTUs for each of the plurality of areas of the current CTU and determines the plurality of depth candidates with a plurality of third CU depths which is within a predetermined second range from the weighted average CU depth.

According to still another exemplary embodiment, the weighted average CU depth may be calculated by assigning a differential weight to the CU depth information among the same areas of the plurality of previous CTUs in accordance with an order of time.

According to still another exemplary embodiment, the predetermined second range may be calculated based on a standard deviation for CU depth information among the same areas of the plurality of previous CTUs.

The selecting unit 430 selects an optimal CU depth among the plurality of depth candidates through a rate-distortion cost calculation on each of the plurality of areas of the current CTU.

According to another exemplary embodiment, the selecting unit 430 may perform a rate-distortion cost calculation only on a part of the entire PU for at least one second CU depth included in the plurality of depth candidates.

The above-described exemplary embodiments of the present disclosure may be created by a computer executable program and implemented in a general use digital computer which operates the program using a computer readable medium.

The computer readable recording medium includes a magnetic storage medium (for example, a ROM, a floppy disk, and hard disk), and an optical reading medium (for example, CD-ROM, a DVD).

For now, the present disclosure has been described with reference to the exemplary embodiments. It is understood to those skilled in the art that the present disclosure may be implemented as a modified form without departing from an essential characteristic of the present disclosure. Therefore, the disclosed exemplary embodiments may be considered by way of illustration rather than limitation. The scope of the present disclosure is presented not in the above description but in the claims and it may be interpreted that all differences within an equivalent range thereto may be included in the present disclosure.

What is claimed is:

1. A history based CU depth determining method which determines depths of a plurality of coding units (CU) included in each of a plurality of coding tree units (CTU) which configures a frame of a video, the method comprising:
dividing a plurality of previous CTUs of a plurality of previous frames which are the same position as a current CTU of a current frame into a plurality of areas to generate depth history information including information of a CU depth for each of the plurality of areas;
determining a plurality of depth candidates for a CU depth for each of the plurality of areas of the current CTU, based on the depth history information; and
selecting an optimal CU depth among the plurality of depth candidates for each of the plurality of areas of the current CTU, through a rate-distortion cost (RD-cost) calculation.

2. The method according to claim 1, wherein in the determining of a plurality of depth candidates, with respect to each of the plurality of areas of the current CTU,
when the CU depth information among the same areas of the plurality of previous CTU matches, the plurality of depth candidates is determined with a first CU depth which is the matching CU depth and at least one second CU depth which is different from the first CU depth within a predetermined first range, and
when the CU depth information does not match, a weighted average CU depth obtained by calculating a weighted average of CU depth information among the same areas of the plurality of previous CU is calculated to determine the plurality of depth candidates with a plurality of third CU depths which is within a predetermined second range from the weighted average CU depth.

3. The method according to claim 2, wherein in the selecting of an optimal CU depth, the rate-distortion cost calculation is performed only on a part of the entire prediction unit (PU) for the at least one second CU depth included in the plurality of depth candidates.

4. The method according to claim 1, wherein the determining of a plurality of depth candidates includes,
with respect to each of the plurality of areas of the current CTU, calculating a weighted average CU depth obtained by weighting an average of the CU depth information among the same areas of the plurality of previous CTUs; and
determining the plurality of depth candidates with a plurality of third CU depths which is within a predetermined second range from the weighted average CU depth.

5. The method according to claim 4, wherein the weighted average CU depth is calculated by assigning a differential weight to CU depth information among the same areas of the plurality of previous CTUs in accordance with an order of time.

6. The method according to claim 4, wherein the predetermined second range is based on a standard deviation for CU depth information among the same areas of the plurality of previous CTUs.

7. The method according to claim 1, wherein the plurality of areas is obtained by dividing the CTU by four.

8. The method according to claim 1, wherein the plurality of previous frames is a predetermined number of previous frames which are connected in order with the current frame.

9. The method according to claim 1, wherein the depth history information includes a maximum value of a depth of at least one CU corresponding to each of the plurality of areas.

10. A history based CU depth determining apparatus which determines a depth of a plurality of CUs included in each of a plurality of CTUs which configures a frame of a video, the apparatus comprising:
a generating unit which divides a plurality of previous CTUs of a plurality of previous frames which are the same position as a current CTU of a current frame into a plurality of areas to generate depth history information including information of a CU depth for each of the plurality of areas;
a candidate determining unit which determines a plurality of depth candidates for a CU depth for each of the plurality of areas of the current CTU, based on the depth history information; and
a selecting unit which selects an optimal CU depth among the plurality of depth candidates through a rate-distortion cost operation on each of the plurality of areas of the current CTU.

11. The apparatus according to claim 10, wherein the candidate determining unit, with respect to each of the plurality of areas of the current CTU, when the CU depth information among the same areas of the plurality of previous CTU matches, determines the plurality of depth candidates with a first CU depth which is the matching CU depth and at least one second CU depth which is different from the first CU depth within a first predetermined range, and
when the CU depth information does not match, calculates a weighted average CU depth obtained by weighting an average of CU depth information among the same areas of the plurality of previous CU to determine the plurality of depth candidates with a plurality of third CU depths which is within a second predetermined range from the weighted average CU depth.

12. The apparatus according to claim 10, wherein the selecting unit performs the rate-distortion cost operation only on a part of the entire prediction unit (PU) for the at least one second CU depth included in the plurality of depth candidates.

13. The apparatus according to claim 10, wherein the candidate determining unit, with respect to each of the plurality of areas of the current CTU, calculates a weighted average CU depth obtained by weighting an average of the CU depth information among the same area of the plurality of previous CTUs; and determines the plurality of depth candidates with a plurality of third CU depths which is within a predetermined second range from the weighted average CU depth.

14. The apparatus according to claim 13, wherein the weighted average CU depth is calculated by assigning a differential weight to CU depth information among the same areas of the plurality of previous CTUs in accordance with an order of time.

15. The apparatus according to claim 13, wherein the predetermined second range is based on a standard deviation for CU depth information among the same areas of the plurality of previous CTUs.

16. The apparatus according to claim 10, wherein the plurality of areas is obtained by dividing the CTU by four.

17. The apparatus according to claim 10, wherein the plurality of previous frames is a predetermined number of previous frames which are connected in order with the current frame.

18. The apparatus according to claim 10, wherein the depth history information includes a maximum value of a depth of at least one CU corresponding to each of the plurality of areas.
